(19) United States
(12) Patent Application Publication
(10) Pub. No.: US 2006/0272911 A1
(43) Pub. Date: Dec. 7, 2006

(54) Jounce bumper, rate cup, and strut mount bottom plate

(75) Inventor: Robert Stuart Feldmann, Londonderry, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymount, MI (US)

(21) Appl. No.: 11/143,286

(22) Filed: Jun. 2, 2005

(51) Int. Cl. B60G 13/00; F16F 9/00

(52) U.S. Cl. 188/321.11; 267/220

(57) ABSTRACT

A strut and jounce bumper assembly is provided including a rate cup and jounce bumper that are capable of moving with the strut rod wherein the rate cup is provided with a concave spherical upper surface that engages a convex spherical surface of a strut mount bottom plate. The design allows use of a larger jounce bumper and striker in applications where the strut rod has large angular travel.

### FIELD OF THE INVENTION

The present invention relates to suspension systems for motor vehicles, and more particularly to a jounce bumper, rate cup, and strut mount bottom plate or upper spring seat for a strut module having a large angular travel of the strut rod.

### BACKGROUND AND SUMMARY OF THE INVENTION

Jounce bumpers are often mounted on a strut assembly where a jounce bumper surrounds a strut rod of a strut suspension. The jounce bumper prevents the cylinder of the strut assembly from heavily impacting the strut mounting assembly. A strut rod that has a large angular travel and a fixed rate cup requires a jounce bumper and striker that are smaller in diameter than a jounce bumper and striker where the strut rod has little or no angular travel.

Accordingly, the present invention provides a rate cup that moves with the strut rod so as to allow use of a larger jounce bumper and striker in applications where the strut rod has a larger angular travel. The larger jounce bumper and striker result in lower stress levels in the jounce bumper. Lower stress levels result in improved durability and performance. An additional advantage of a rate cup that moves with the strut rod is that the striker is able to directly contact the jounce bumper without an angular offset. The jounce bumper is not likely to bulge out from between the striker and rate cup when there is no angular offset. This results in more consistent jounce bumper performance when comparing load versus deflection.

Also, by contacting the jounce bumper with no angular offset, the striker is subjected to lower side loads which results in lower side loads to the rod guide and bearing. Lower side loads at the rod guide and bearing result in less friction in the strut assembly and, therefore, smoother strut performance. The design also allows the rate cup and jounce bumper to move with the angular travel of the strut rod, but it does not transmit jounce loads to the strut rod and into the elastomeric component of the strut mount. Therefore, the elastomeric component of the strut mount does not have to be designed to support jounce loads. The strut mount will be less costly, provide better noise vibration and harshness performance, and better durability. With the jounce bumper rate cup that is mounted on the strut rod, free to slide along the strut rod and free to move relative to the strut mount, the upper end of the rate cup, according to the principles of the present invention, is spherical as opposed to a typical design which is flat, with the concave side toward the strut mount. The center of the spherical surface is located at the center of oscillation of the strut rod. A strut mount bottom plate or upper spring seat that is part of the strut mount assembly is spherical, with the convex side toward the rate cup and concentric with the spherical surface of the rate cup. The jounce bumper is mounted onto the strut rod and inside the rate cup. A disk of elastomeric material is installed between the rate cup and the strut mount bottom plate or upper spring seat to prevent the rate cup and strut mount bottom plate or upper spring seat from hitting each other and causing noise or damage to each other.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of a strut assembly having a jounce bumper rate cup and strut mount bottom plate or upper spring seat according to the principles of the present invention;

FIG. 2 is a cross-sectional view of a second embodiment of a strut mount assembly having a jounce bumper rate cup and strut mount bottom plate or upper spring seat according to the principles of the present invention;

FIG. 3 is a cross-sectional view of a third embodiment of a strut mount assembly having a jounce bumper rate cup and strut mount bottom plate or upper spring seat according to the principles of the present invention; and

FIG. 4 is a cross-sectional view of a fourth embodiment of a strut mount assembly having a jounce bumper rate cup and strut mount bottom plate or upper spring seat according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

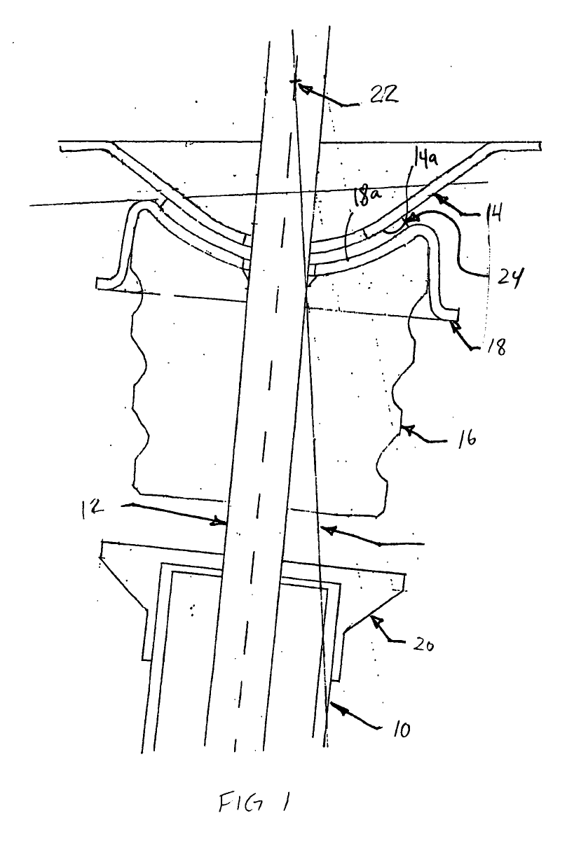

With reference to FIG. 1, a shock absorber tube 10 of a vehicle suspension system is shown including a strut rod 12 extending therefrom. Strut rod 12 is adapted to be mounted to a strut mount. As is known in the art, the strut mount includes a top plate, bottom plate, and an elastomeric element disposed therebetween to which the strut rod 12 is mounted. Optionally, the strut mount can also include a spring seat and bearing mounted to the bottom plate of the strut mount. As illustrated in FIGS. 1-4, reference numeral 14 is an illustration of the lowermost portion of the strut mount which can include a bottom plate of the strut mount or, if included, the spring seat of a spring seat and bearing assembly. Accordingly, throughout this application, reference numeral 14 is used to reference “the strut mount bottom plate or spring seat.”

A jounce bumper 16 and rate cup 18 are each slidably mounted on the strut rod 12. The jounce bumper 16 is mounted to the rate cup 18. A striker 20 is mounted to an upper surface of the shock absorber tube 10 and is designed to impact the jounce bumper 16 when the strut rod 12 reaches a bottom-most position relative to the shock absorber tube 10.

In conventional strut and jounce bumper assemblies, the bottom plate of the strut mount and the rate cup are typically flat. However, in the present invention, the upper end of the rate cup 18 is spherical with the concave side upward toward the strut mount bottom plate or spring seat 14. The center of the spherical surface 18a is located at the center of oscillation 22 of the strut rod 12. The lower end surface 14a of the strut mount bottom plate or spring seat 14 is also generally spherical, with the convex side toward the rate cup 18, with the generally spherically surfaces 18a and 14a being concentric. It should be understood that the convex and concave surfaces can be reversed so as to be concave as surface 14a and convex on surface 18a. A thin disk of plastic or elastomeric material 24 is installed on the strut rod 12 between the rate cup 18 and bottom plate or spring seat 14 to prevent the rate cup 18 and bottom plate or spring seat 14 from hitting each other and causing noise or damage to each other.

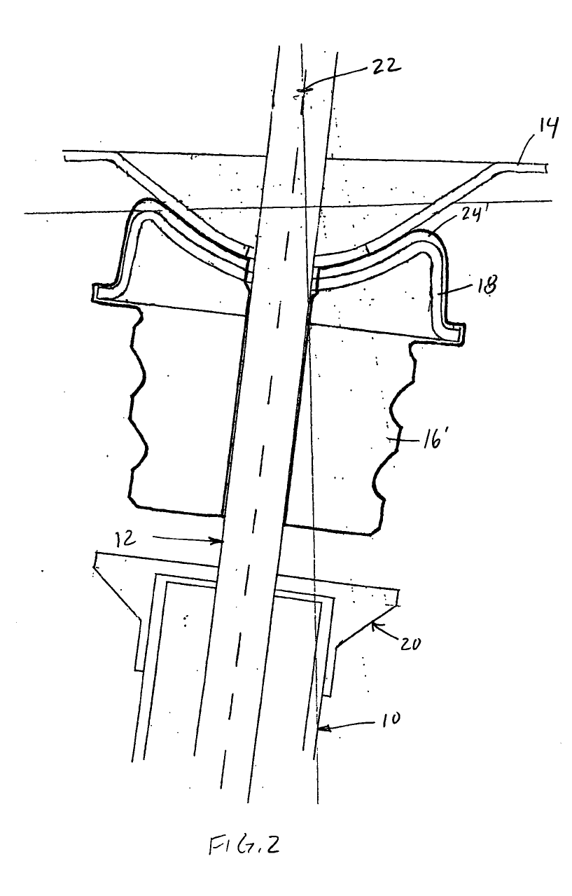

As an alternative embodiment as shown in FIG. 2, the elastomeric material of the jounce bumper could be molded around the rate cup to provide the jounce bumper 16′ and also to provide a thin disk of elastomeric material 24′ between the rate cup 18 and strut mount bottom plate or spring seat 14.

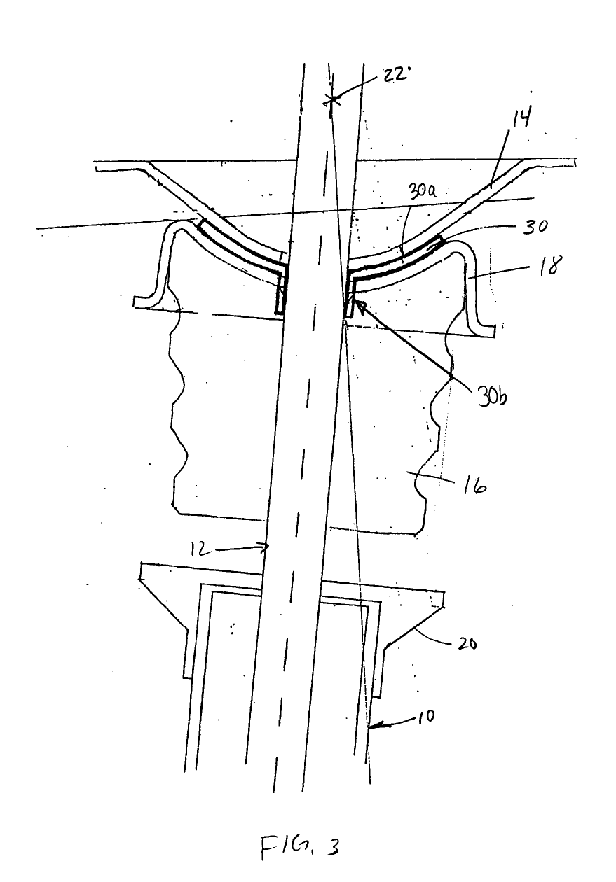

A still further alternative design as illustrated in FIG. 3 includes the use of a separate plastic bushing 30 installed between the rate cup 18 and the strut rod 12. In this embodiment, the separate plastic bushing 30 includes a spherical portion 30a and a cylindrical bushing portion 30b slidably fitted on the strut rod 12. The plastic bushing 30 provides a more rigid alignment between the rate cup 16 and strut rod 12. It should be understood that the bushing can be made of plastics, elastomeric materials, or combinations thereof.

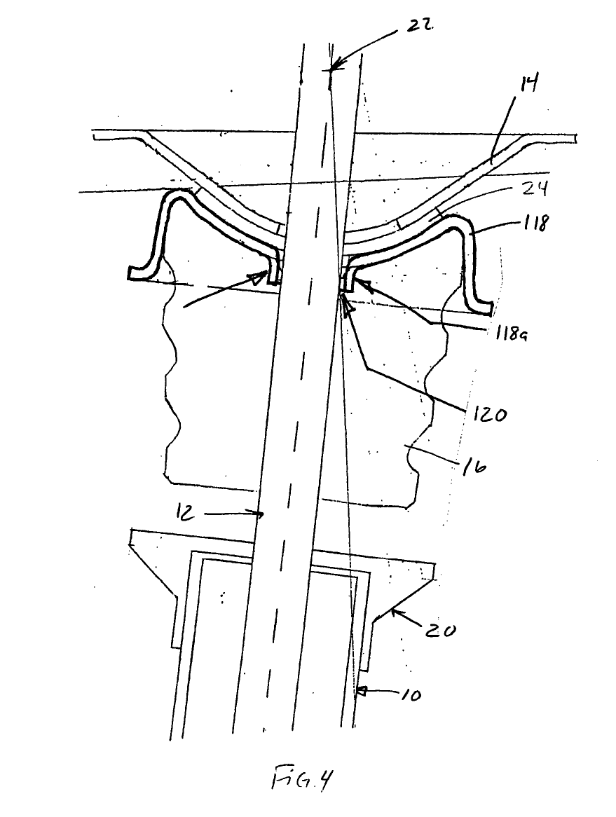

A still further alternative design, as illustrated in FIG. 4, includes a modified rate cup 118 including a cylindrical section 118a that fits closely to the strut rod 12 to provide more rigid alignment between the rate cup 118 and strut rod 12. This alternative may include a sleeve 120 made of plastic or an elastomeric material which can be formed as a separate piece or overmolded on the rate cup 118 along with the jounce bumper to prevent the cup and rod from coming into contact with each other and causing noise. The disk of elastomeric or plastic material 24 is also provided between the rate cup 18 and strut mount bottom plate or spring seat 14. It should be understood that the sleeve 120 and disk 24 may be combined into one component such as bushing 30, and can be made of plastics, elastomeric materials, or combinations thereof.

The present invention is provided with a rate cup 18, 118 that moves with the strut rod 12, and the rate cup 18, 118 includes a concave spherical upper surface 18a that engages with a convex spherical surface 14a of a strut mount bottom plate or spring seat 14. The rate cup 18, 118 that moves with the strut rod 12 allows the use of a larger jounce bumper 16 and striker 20 in applications where the strut rod 12 has large angular travel. A larger jounce bumper 16 and striker 20 result in lower stress levels in the jounce bumper and, thus, result in improved durability and performance. The movable rate cup 18, 118 allows the striker 20 to make contact with the jounce bumper 16 directly and without an angular offset such that the jounce bumper 16 is less likely to bulge out from between the striker 20 and rate cup 18 when there is no angular offset. This results in more consistent jounce bumper performance. The striker 20, by contacting the jounce bumper 16 with no angular offset, is subjected to lower side loads which results in lower side loads to the rod guide and bearing. Lower side loads at the rod guide and bearing result in less friction in the strut assembly and, therefore, smoother strut performance. The design also allows the rate cup 18 and jounce bumper 16 to move with the angular travel of the strut rod 12 and to transmit distributed forces between the rate cup 18 and strut mount bottom plate or spring seat 14 without transmitting forces to the elastomeric element of the strut mount. The strut mount of the present invention will be less costly, provide better noise vibration harshness performance, and better durability performance.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A strut assembly, comprising:
a strut rod;
a jounce bumper located adjacent to the strut rod;
a jounce bumper cup attached to the jounce bumper, said jounce bumper cup having one of a concave or convex surface facing away from said jounce bumper; and
a strut mount attached to said strut rod, wherein said strut mount includes the other of said convex or concave surface facing said jounce bumper cup.

2. The strut assembly according to claim 1, further comprising an elastomeric material disposed on one of said concave surface of said jounce bumper cup and said convex surface of said strut mount.

3. The strut assembly according to claim 2, wherein said elastomeric material is disposed on said concave surface of said jounce bumper cup.

4. The strut assembly according to claim 3, wherein said jounce bumper and said elastomeric material are integrally molded on said jounce bumper cup.

5. The strut assembly according to claim 2, further comprising a bushing portion attached to said elastomeric material and extending axially along said strut rod.

6. The strut assembly according to claim 5, wherein said bushing portion is formed from plastic.

7. The strut assembly according to claim 5, wherein said bushing portion is formed from said elastomeric material.

8. The strut assembly according to claim 1, further comprising a plastic material disposed on one of said concave surface of said jounce bumper cup and said convex surface of said strut mount.

9. The strut assembly according to claim 8, further comprising a bushing portion attached to said plastic material and extending axially along said strut rod.

10. The strut assembly according to claim 9, wherein said bushing portion is formed from plastic.

11. The strut assembly according to claim 1, wherein said jounce bumper cup includes a cylindrical section extending axially along said strut rod.

12. The strut assembly according to claim 11, further comprising a bushing between said cylindrical section and said strut rod.

13. The strut assembly according to claim 12, wherein said bushing is made from plastic.

14. The strut assembly according to claim 12, wherein said bushing is made from elastomeric material.

15. The strut assembly according to claim 1, wherein said concave and said convex surfaces are generally partially spherical.
